(19) United States
(12) Patent Application Publication
(10) Pub. No.: US 2006/0227875 A1
(43) Pub. Date: Oct. 12, 2006

(54) System, and method for DC coefficient prediction

(76) Inventors: Bhaskar Sherigar, Bangalore (IN); Anand Tongle, Bangalore (IN)

Correspondence Address: MCANDREWS HELD & MALLOY, LTD, 500 WEST MADISON STREET, SUITE 3400, CHICAGO, IL, 60661, US

(21) Appl. No.: 11/092,339

(22) Filed: Mar. 29, 2005

(51) Int. Cl. H04N 11/04; H04N 7/12; H04B 1/66; H04N 11/02

(52) U.S. Cl. 375/240.18; 375/240.24

(57) ABSTRACT

Presented herein are system(s), method(s), and apparatus for DC coefficient prediction. In one embodiment, there is presented a method for predicting coefficients for a macroblock. The method comprises providing at least one coefficient prediction direction for at least one neighboring block of a particular block for predicting AC coefficients of the particular block; predicting a DC coefficient for the particular block; and overwriting a DC coefficient for a neighboring block of the particular block.

### RELATED APPLICATIONS

This application is related to “SYSTEM, METHOD, AND APPARATUS FOR AC COEFFICIENT PREDICTION”, application Ser. No. ______ (Attorney Docket No. 15908US01) filed ______, by Sherigar, et. al., which is incorporated herein by reference in its entirety for all purposes.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Various video compression standards, such as Advanced Video Coding (AVC) (also known as MPEG-4, Part 10, and ITU-H.264) use DC coefficient prediction to achieve greater compression. The video compression standards typically divide portions of pictures forming the video into blocks, macroblocks, slices etc. Pixel data from the block is transformed to the frequency domain and represented by frequency coefficients.

The frequency coefficients include a DC coefficient and AC coefficients. The DC coefficient is not associated with a frequency and it has a zero frequency. The AC coefficients are associated with various frequencies.

In AVC, the AC coefficients in first row of a block or first column of a block can be predicted from the respective rows or columns of AC frequency coefficients of either a top neighboring block or a left neighboring block. The particular one of the top neighboring block or left neighboring block are determined by the DC coefficients of the top, left, and top left (diagonal) neighboring blocks.

During decoding, decoders typically decode macroblocks in raster order. Raster order begins with the top row of a picture, from left to right, proceeding to the next row downwards. While decoding the macroblocks, the decoder examines data from the top, left, and top left neighboring macroblocks.

Decoders typically include processors, or hardware accelerators, and bulk memory (typically DRAM). Generally, the DRAM is not suitable for small amount of storage, fast and high numbers of accesses. The processors and hardware accelerators utilize faster on-chip memory for storing data that is accessed frequently. The on-chip memory is more expensive and also consumes a great amount of area on the chip.

When the decoder decodes a macroblock, the macroblock includes information that may be used to decode the current macroblock's bottom, and bottom right neighbors. However, the current macroblock's bottom and bottom right neighbors will be decoded a full row later in the raster scan order. It is therefore, impractical to store the entire information from the macroblock from the time the macroblock is decoded until decoding it's bottom and bottom left neighbors.

Further limitations and disadvantages of convention and traditional approaches will become apparent to one of ordinary skill in the art through comparison of such systems with the present invention as set forth in the remainder of the present application with reference to the drawings.

### BRIEF SUMMARY OF THE INVENTION

Presented herein are system(s), method(s), and apparatus for DC coefficient prediction.

In one embodiment, there is presented a method for predicting coefficients for a macroblock. The method comprises providing at least one coefficient prediction direction for at least one neighboring block of a particular block for predicting AC coefficients of the particular block; predicting a DC coefficient for the particular block; and overwriting a DC coefficient for a neighboring block of the particular block.

In another embodiment, there is presented a system for predicting coefficients for a macroblock. The system comprises a circuit and another circuit. The circuit provides at least one coefficient prediction direction for at least one neighboring block of a particular block for predicting AC coefficients of the particular block. The another circuit predicts a DC coefficient for the particular block. The circuit overwrites a DC coefficient for a neighboring block of the particular block.

These and other advantages and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram describing certain aspects of encoding in accordance with Advanced Video Coding;

FIG. 2 is a block diagram describing an exemplary video decoder in accordance with an embodiment of the present invention;

FIG. 3 is a block diagram of an inverse quantizer in accordance with an embodiment of the present invention;

FIG. 4 is a block diagram describing decoding macroblocks in accordance with an embodiment of the present invention;

FIG. 5 is a block diagram of a DC predictor in accordance with an embodiment of the present invention; and

FIG. 6 is a flow diagram for providing DC coefficients in accordance with an embodiment of the present invention.

### DETAILED DESCRIPTION OF THE INVENTION

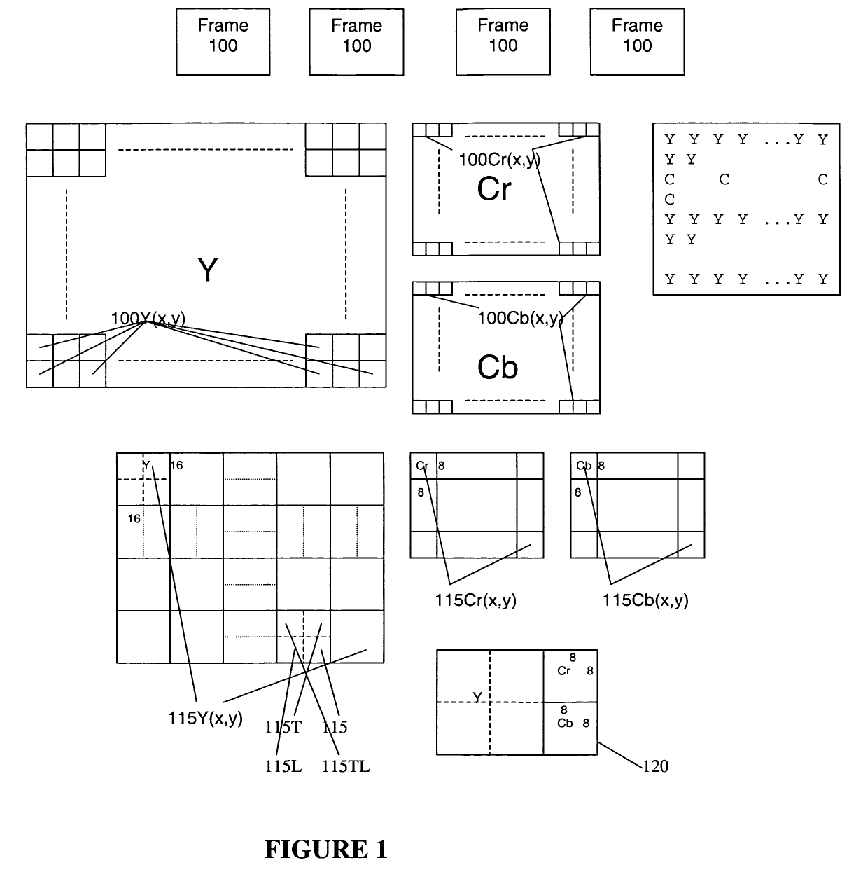

Referring now to FIG. 1, there is illustrated a block diagram of a picture 100. A video camera captures picture 100 from a field of view during time periods known as frame durations. The successive pictures 100 form a video sequence. A picture 100 comprises two-dimensional grid(s) of pixels 100(x,y).

For color video, each color component is associated with a two-dimensional grid of pixels. For example, a video can include a luma, chroma red, and chroma blue components. Accordingly, the luma, chroma red, and chroma blue components are associated with a two-dimensional grid of pixels 100Y(x,y), 100Cr(x,y), and 100Cb(x,y), respectively. When the grids of two dimensional pixels 100Y(x,y), 100Cr(x,y), and 100Cb(x,y) from the frame are overlayed on a display device 110, the result is a picture of the field of view at the frame duration that the frame was captured.

Generally, the human eye is more perceptive to the luma characteristics of video, compared to the chroma red and chroma blue characteristics. Accordingly, there are more pixels in the grid of luma pixels 100Y(x,y) compared to the grids of chroma red 100Cr(x,y) and chroma blue 100Cb(x,y). In the MPEG 4:2:0 standard, the grids of chroma red 100Cr(x,y) and chroma blue pixels 100Cb(x,y) have half as many pixels as the grid of luma pixels 100Y(x,y) in each direction.

The chroma red 100Cr(x,y) and chroma blue 100Cb(x,y) pixels are overlayed the luma pixels in each even-numbered column 100Y(x, 2y) between each even, one-half a pixel below each even-numbered line 100Y(2x, y). In other words, the chroma red and chroma blue pixels 100Cr(x,y) and 100Cb(x,y) are overlayed pixels 100Y(2x+½, 2y).

Luma pixels of the picture 100Y(x,y) can be divided into 8×8 pixel 100Y(8x−>8x+7, 8y−>8y+7) blocks 115Y(x,y). For four blocks of luma pixels 115Y(x,y), 115Y(x+1,y), 115Y(x, y+1), 115Y(x+1, y+1), there is a corresponding 8×8 block of chroma red pixels 115Cr(x,y) and chroma blue pixels 115Cb(x,y) comprising the chroma red and chroma blue pixels that are to be overlayed the block of luma pixels 115Y(x,y). A block of luma pixels 115Y(x,y), and the corresponding blocks of chroma red pixels 115Cr(x,y) and chroma blue pixels 115Cb(x,y) are collectively known as a macroblock 120. The macroblocks 120 can be grouped into groups known as slice groups 122.

AVC specifies the use of spatial prediction, temporal prediction, and frequency transformations to reduce the amount of data for coding the blocks 115. Generally, the blocks 115 are represented as a residual difference, or prediction error, between the block 115 and another reference block 115. The prediction error itself corresponds to pixel values.

The prediction error is then transformed to the frequency domain and represented by frequency coefficients F₀₀ . . . F₇₇. The frequency coefficients include a DC coefficient F₀₀ and AC coefficients F₀₁ . . . F₇₇, in intra picture type blocks. Inter picture type blocks do not contain a DC component and all components are treated as AC components. For such blocks DC or AC prediction does not exist. To reduce the amount of data required to code each block 115, the AC frequency coefficients F₀₁ . . . F₀₇, top pixel row of a block are predicted from the respective positional AC coefficients of the top 115T, or from first column of left 115L neighboring blocks, depending on the DC coefficients of the top 115T, left 115L, and top left 115TL neighboring block. The AC coefficients of block 115 which are predicted from the one of the left 115L or top 115T neighboring blocks with the greatest absolute difference from the top left 115TL neighboring block. In any case the maximum coefficients predicted per block are eight, either from top 115T or from left 115L.

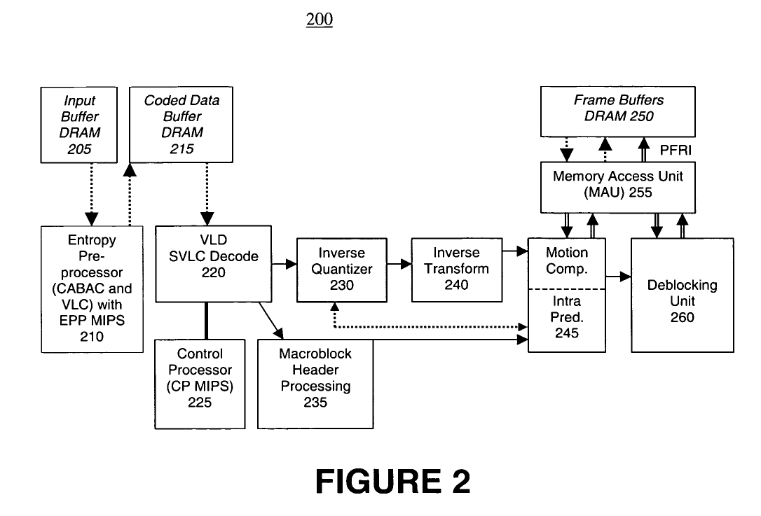

Referring now to FIG. 2, there is illustrated a block diagram describing an exemplary video decoder system 200 in accordance with an embodiment of the present invention. The video decoder 200 comprises an input buffer DRAM 205, an entropy pre-processor 210, a coded data buffer DRAM 215, a variable length code decoder 220, a control processor 225, an inverse quantizer 230, a macroblock header processor 235, an inverse transformer 240, a motion compensator and intrapicture predictor 245, frame buffers 250, a memory access unit 255, and a deblocker 260.

The input buffer DRAM 205, entropy pre-processor 210, coded data buffer DRAM 215, and variable length code decoder 220 together decode the variable length coding associated with the video data, resulting in pictures 100 represented by macroblocks 120.

The inverse quantizer 230 predicts the first row or column of blocks of quantized frequency coefficients and inverse quantizes. The macroblock header processor 235 examines side information, such as parameters that are encoded with the macroblocks 120.

The inverse transformer 240 transforms the blocks of frequency coefficients F₀₀ . . . F₇₇, thereby resulting in the prediction error PE. The motion compensator and intrapicture predictor 245 decodes the macroblock 120 pixels from the prediction error PE. The decoded macroblocks 120 are stored in frame buffers 250 using the memory access unit 255. A deblocker 260 is used to deblock adjacent macroblocks 120.

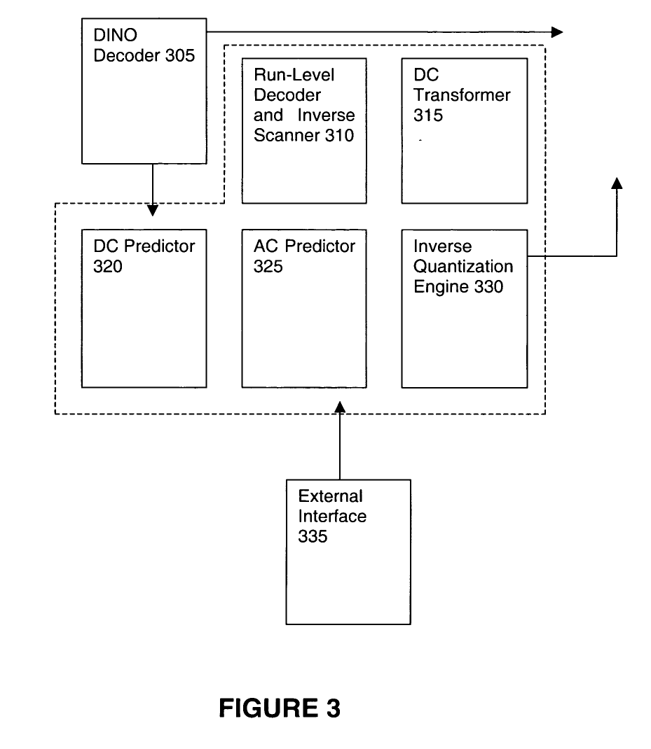

Referring now to FIG. 3, there is illustrated a block diagram describing an exemplary inverse quantizer 230 in accordance with an embodiment of the present invention. The inverse quantizer 230 comprises a DINO (Data In and Out) Decoder 305, a run level decoder and inverse scanner 310, a DC transformer 315, a DC predicter 320, an AC predictor 325, an inverse quantization engine 330, external interfaces 335, and a DINO encoder 340.

The external interfaces 335 initialize the inverse quantizer 230 at every picture header level with the parameters. The run-level decode and inverse scanner 310 does the “zero filling” operation decided by the run count of run pairs and inverse scans by providing a correct address of a buffer based on a look-up table.

AC and DC prediction can be used in certain standards such as AVC. Where DC prediction is enabled, the DC predictor 320 performs the DC prediction functions and provides the results to the AC predictor 325. Where AC prediction is enabled, the AC predictor 325 performs the AC prediction functions. The AC predictor 325 and AC prediction can comprise, for example, the system(s), method(s), and apparatus described in “SYSTEMS, METHODS, AND APPARATUS FOR AC PREDICTION”, Ser. No. ______, filed ______ by Sherigar, et. al., and incorporated herein by reference.

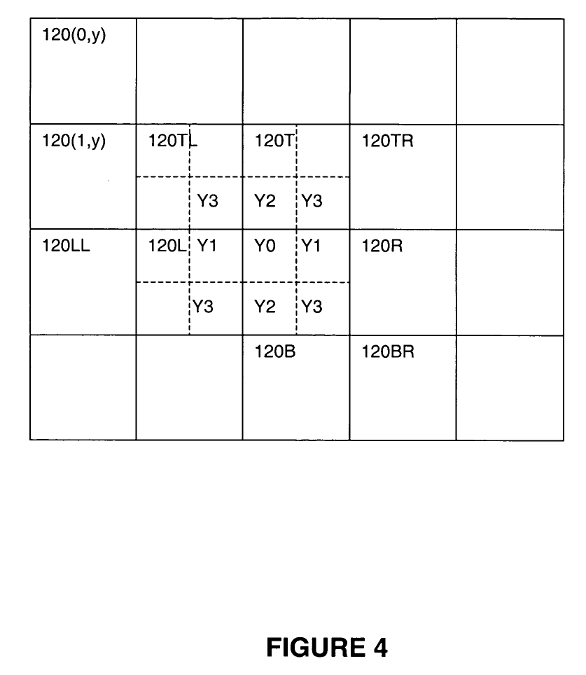

Referring now to FIG. 4, there is illustrated a block diagram describing decoded macroblocks 120 in accordance with an embodiment of the present invention. The video decoder 200 decodes the macroblocks 120 in raster order. In raster order, the first row of macroblocks 120(0,y) is decoded from left to right, proceeding to the next row 120(1,y), and downwards. The blocks 115 are represented by AC coefficients F₀₀ . . . F₇₇, and DC coefficients F₀₀. The AC coefficients F₀₁ . . . F₀₇, are predicted from the AC coefficients of either the top neighboring block 115T, or the AC coefficients F₁₀ . . . F₇₀, are predicted from the AC coefficients from the left neighboring block 115L.

It is noted that in a macroblock 120 comprising four luma blocks 115Y, the top and left neighboring blocks for the top left block Y0 are located in the top 120T and left 120L neighboring macroblocks. The top neighboring block for the top right block Y1 is located in the top 120T neighboring macroblocks. The left neighboring block for the bottom left block Y2 is located in the left 120L neighboring macroblock. Additionally, the blocks Y1, Y2, and Y3 are neighboring blocks for blocks in the right 120R, bottom 120B, and bottom right 120BR, neighboring macroblocks 120.

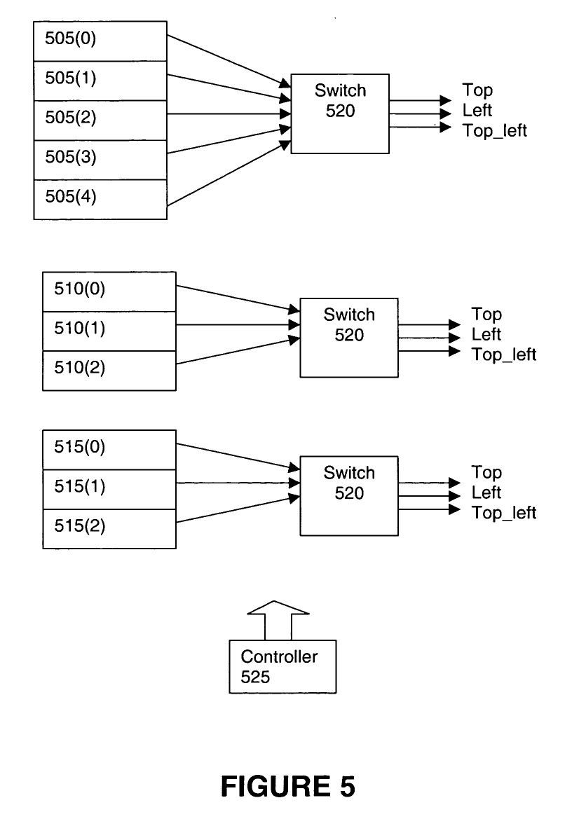

Referring now to FIG. 5, there is illustrated a block diagram of a DC predictor 320 in accordance with an embodiment of the present invention. The DC predictor 320 comprises a set of luma DC registers 505(0) . . . 505(4), chroma red DC registers 510(0) . . . 510(2), and chroma blue DC registers 515(0) . . . 515(2) for storing DC coefficients. The registers 505 store the DC coefficients and provide the prediction direction to the AC predictor 325. A switch 520 is connected to the registers 505(0) . . . 505(4) and selects a particular set of three unique registers 505(0) . . . 505(4). These three registers always point to top 115T, left 115L and top left 115TL. This way the prediction direction calculator always gets a fixed pointer irrespective of the block under consideration. At the end of every macroblock decode, the pointers are adjusted for the sequence of a macroblock decode start. The foregoing are controller by a controller 525.

Initially, upon decoding a macroblock 120, the luma DC registers 505 store the DC coefficients for blocks Y1 and Y3 of the left neighboring macroblock 120L, for block Y2 of top neighboring macroblock 120T and block Y3 of the top left neighboring macroblock 120TL. After completing the DC prediction of Y0, the register corresponding to Y3 of macroblock 120TL is replaced with the new DC value of block Y0 of macroblock 120. Similarly register corresponding to block Y2 of macroblock 120T is replaced by the result of block Y1 of macroblock 120. This sequence contnues till block Y3 of macroblock 120.

The AC predictor 325 accesses the result of DC coefficients prediction as the prediction direction for blocks in the macroblock 120. The DC predictor 320 predicts the DC coefficients for block Y0, and overwrites the DC coefficient for block Y3 in the top left macroblock 120TL. The foregoing is repeated for blocks Y1 . . . Y3, wherein the DC coefficient for each block overwrites the DC coefficient for the top neighboring blocks, Y2 (of macroblock 120T), Y1 (of macroblock 120L), and Y1, respectively.

After the luma blocks Y0 . . . Y3 of macroblock 120 are decoded, the DC coefficients for blocks Y1, Y2, Y3, of macroblock 120, Y3 of the top macroblock 120T, and Y3 of the left macroblock 120L are stored in the registers 505. It is noted that blocks Y1, Y3 of macroblock 120 and Y3 of the top macroblock 120T are the top, left, and top left neighboring blocks for blocks Y0 and Y2 of macroblock 120R. The DC coefficients for blocks Y2 and Y3 for macroblock 120T are fetched by the DC predictor and overwrite the DC coefficients for Y2, and Y3 of the left neighboring macroblock 120L.

For the chroma blocks, Cr, Cb, of macroblock 120, the registers 510 and 515 initially store the DC coefficients for the chroma red and blue blocks for the top left neighboring macroblock 120TL and the left neighboring macroblock 120L, respectively. The DC predictor 320 fetches and stores the DC coefficient for the chroma red and blue blocks for the top neighboring macroblock 120T in registers 510 and 515. The result of foregoing DC predictions are provided to the AC predictor 325 as the prediction direction for predicting the AC coefficients either from top row or left column of the chroma red and blue blocks. After decoding the AC coefficients of the chroma red and blue blocks, the DC coefficients of the red and blue blocks overwrite the DC coefficient of the chroma red and blue blocks of the top left neighboring macroblock 120TL. At this point, the registers 510 and 515 store the DC coefficients for the chroma red and blue blocks, and the DC coefficients for the chroma red and blue blocks of the top neighboring macroblock 120T and the left neighboring macroblock 120L.

It is noted that the chroma blocks and the chroma blocks of the top neighboring macroblocks 120T are left and top left neighboring blocks to the chroma blocks of the right neighboring macroblock. The top neighboring blocks are the chroma blocks of macroblock 120TR. Accordingly, the DC coefficient of the chroma blocks of macroblock 120TR overwrite the DC coefficient for the chroma blocks of macroblock 120L.

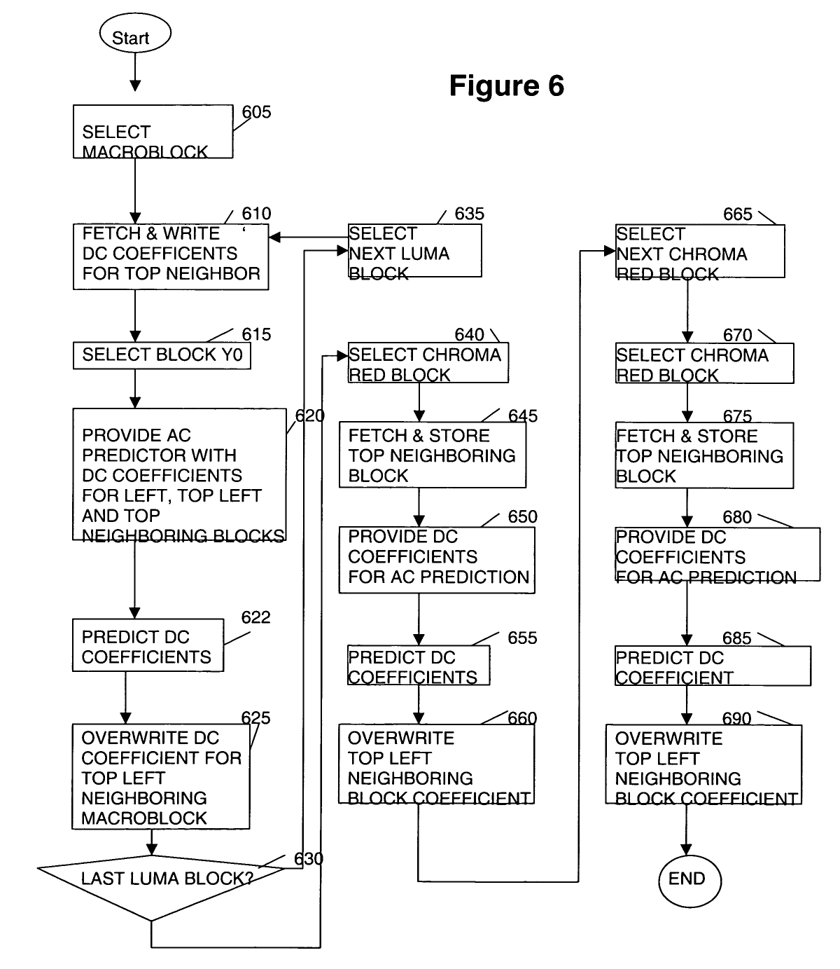

Referring now to FIG. 6, there is illustrated a flow diagram for predicting coefficients for blocks of a macroblock 120. At 605, a macroblock 120 is selected. Initially, the luma DC registers 505 store the DC coefficients for blocks Y1 and Y3 of the left neighboring macroblock 120L, and block Y3 of the top left neighboring macroblock 120TL. The luma DC registers 505 may also store the DC coefficients for blocks Y2 of the left neighboring macroblock 120L and block Y3 of the second left neighboring macroblock 120LL. At 610 the DC predictor 320 fetches and writes DC coefficients for blocks Y2 and Y3 for the top neighboring macroblock 120T to the registers 505. Where the registers 505 store the DC coefficients for blocks Y2 of the left neighboring macroblock 120L and block Y3 of the second left neighboring macroblock 120LL, the DC predictor 320 overwrites the foregoing with the DC coefficients for blocks Y2 and Y3 of the top neighboring macroblock 120T.

At 615, block Y0 is selected for coefficient prediction. The table below indicates the order that the blocks are selected, the neighboring information, and the overwrite information.

| Selection | Left | Top Left | Top | |
|---|---|---|---|---|
| Order | Neighbor | Neighbor | Neighbor | Overwrite |
| Y0 | Y1 of 120L | Y3 of 120TL | Y2 of 120T | Y3 of 120TL |
| Y1 | Y0 | Y2 of 120T | Y3 of 120T | Y2 of 120T |
| Y2 | Y3 of 120L | Y1 of 120L | Y0 | Y1 of 120L |
| Y3 | Y2 | Y0 | Y1 | Y0 |

At 620, the DC predictor 320 provides prediction direction information to the AC predictor 325 calculated from the DC coefficients for left, top left, and top neighboring blocks for the blocks selected during 615. At 620, the DC predictor 320 predicts the DC coefficients for the block selected during 615, and overwrites (625) the DC coefficient for the top left neighboring block. At 630, a determination is made whether the last luma block is predicted. If at 630, the last luma block is not predicted, the next luma block is selected at 635 and 620 is repeated.

If at 630, the last luma block is predicted, at 640, the chroma red block Cr is selected. For the chroma blocks, Cr, Cb, of macroblock 120, the registers 510 initially store the DC coefficients for the chroma red for the top left neighboring macroblock 120TL and the left neighboring macroblock 120L, respectively. The registers 510 may also store the DC coefficient for the chroma red block in the second left neighboring macroblock 120LL. The DC predictor 320 fetches and the registers 510 stores (645) the DC coefficient for the chroma red block of the top neighboring macroblock 120T in register 510. Where the registers 510 store the DC coefficient for the chroma red block in the second left neighboring macroblock 120LL, the DC coefficient for the chroma read block in the second left neighboring macroblock 120LL is overwritten.

The DC coefficients stored in the registers 510 are provided (650) to the AC predictor 325 for decoding the AC coefficients of the chroma red block. After decoding the AC coefficients of the chroma red, the DC coefficients of the chroma red blocks is decoded (655) and overwrites (660) the DC coefficient of the chroma red block of the top left neighboring macroblock 120TL.

At 665, the chroma red block Cr is selected. For the chroma blocks, Cr, Cb, of macroblock 120, the registers 515 initially store the DC coefficients for the chroma red for the top left neighboring macroblock 120TL and the left neighboring macroblock 120L, respectively. The registers 515 may also store the DC coefficient for the chroma red block in the second left neighboring macroblock 120LL. The DC predictor 320 fetches and the registers 510 stores (670) the DC coefficient for the chroma red block of the top neighboring macroblock 120T in register 510. Where the registers 510 store the DC coefficient for the chroma red block in the second left neighboring macroblock 120LL, the DC coefficient for the chroma read block in the second left neighboring macroblock 120LL is overwritten.

The DC coefficients stored in the registers 510 are provided (675) to the AC predictor 325 for decoding the AC coefficients of the chroma red block. After decoding the AC coefficients of the chroma red, the DC coefficients of the chroma red blocks is decoded (680) and overwrites (685) the DC coefficient of the chroma red block of the top left neighboring macroblock 120TL.

The degree of integration of the system may primarily be determined by speed and cost considerations. Because of the sophisticated nature of modern processor, it is possible to utilize a commercially available processor, which may be implemented external to an ASIC implementation. If the processor is available as an ASIC core or logic block, then the commercially available processor can be implemented as part of an ASIC device wherein certain functions can be implemented in firmware. In one embodiment, the foregoing can be integrated into an integrated circuit. Additionally, the functions can be implemented as hardware accelerator units controlled by the processor.

While the invention has been described with reference to certain embodiments, it will be understood by those skilled in the art that various changes may be made and equivalents may be substituted without departing from the scope of the invention. In addition, many modifications may be made to adapt particular situation or material to the teachings of the invention without departing from its scope. Therefore, it is intended that the invention not be limited to the particular embodiment(s) disclosed, but that the invention will include all embodiments falling within the scope of the appended claims.

1. A method for predicting coefficients for a macroblock, said method comprising:
providing at least one coefficient prediction direction for at least one neighboring block of a particular block for predicting AC coefficients of the particular block;
predicting a DC coefficient for the particular block; and
overwriting a DC coefficient for a neighboring block of the particular block.

2. The method of claim 1, wherein the at least one neighboring block comprises a left neighboring block and a top neighboring block.

3. The method of claim 1, wherein the at least one neighboring block comprises a top left neighboring block, and wherein overwriting the DC coefficient for a neighboring block of the particular block further comprises overwriting the DC coefficient for the top left neighboring block.

4. The method of claim 1, further comprising:
predicting the AC coefficients of the particular block.

5. The method of claim 1, further comprising:
fetching a DC coefficient for a top neighboring block; and
storing the DC coefficient for the top neighboring block.

6. The method of claim 1, wherein the block comprises a luma block.

7. A system for predicting coefficients for a macroblock, said system comprising:
a circuit for providing at least one coefficient prediction direction for at least one neighboring block of a particular block for predicting AC coefficients of the particular block;
another circuit for predicting a DC coefficient for the particular block; and
wherein the circuit overwrites a DC coefficient for a neighboring block of the particular block.

8. The system of claim 7, wherein the at least one neighboring block comprises a left neighboring block and a top neighboring block.

9. The system of claim 7, wherein the at least one neighboring block comprises a top left neighboring block, and wherein overwriting the DC coefficient for a neighboring block of the particular block further comprises overwriting the DC coefficient for the top left neighboring block.

10. The system of claim 7, further comprising:
an AC predictor for predicting the AC coefficients of the particular block.

11. The system of claim 7, wherein the another circuit fetches a DC coefficient for a top neighboring block; and wherein the circuit stores the DC coefficient for the top neighboring block.

12. The system of claim 7, wherein the particular block comprises a luma block.
